(19) United States
(12) Patent Application Publication
(10) Pub. No.: US 2025/0260555 A1
(43) Pub. Date: Aug. 14, 2025

(54) METHOD FOR PROCESSING HOMOMORPHIC CIPHERTEXT AND ELECTRONIC APPARATUS

(71) Applicants: CRYPTO LAB INC., Seoul (KR); SEOUL NATIONAL UNIVERSITY R&DB FOUNDATION, Seoul (KR)

(72) Inventors: Heon Hui Jung, Pyeongtaek-si (KR); Yunheung Paek, Seoul (KR); Kevin Nam, Seoul (KR); Seungjin Ha, Daegu (KR); Junbum Shin, Suwon-si (KR); Inkwan Yu, Seoul (KR); Sunchul Jung, Seoul (KR); Jungjoo Seo, Seoul (KR)

(21) Appl. No.: 19/052,442

(22) Filed: Feb. 13, 2025

(30) Foreign Application Priority Data
Feb. 13, 2024 (KR) 10-2024-0020430
Jan. 21, 2025 (KR) 10-2025-0008424

(51) Int. Cl. H04L 9/00; H04L 9/08; H04L 9/14; H04L 9/30

(52) U.S. Cl. CPC H04L 9/008; H04L 9/0894; H04L 9/14; H04L 9/30

(57) ABSTRACT

An electronic apparatus includes: a communication device; a memory storing a first secret key and a first public key corresponding to the first secret key, and storing at least one instruction; and a processor configured to execute the at least one instruction, wherein the processor is configured to generate a switching key based on a second public key and the first secret key if the processor receives the second public key from a terminal device corresponding to a first user, and control the communication device to transmit the first public key to the terminal device, the switching key being a key that enables a homomorphic ciphertext encrypted using the first public key to be decrypted using a second secret key corresponding to the second public key.

### CROSS-REFERENCE TO RELATED APPLICATIONS

This application is based on and claims priority under 35 U.S.C. § 119 to Korean Patent Application No. 10-2024-0020430, filed on Feb. 13, 2024, and Korean Patent Application No. 10-2025-0008424, filed on Jan. 21, 2025 in the Korean Intellectual Property Office, the disclosures of which are incorporated by reference herein in its entirety.

### BACKGROUND TECHNICAL FIELD

The present disclosure relates to a method for processing a homomorphic cipher text and an electronic apparatus, in which information is not leaked between respective electronic apparatuses even if the plurality of electronic apparatuses perform a specific operation together.

### BACKGROUND

In accordance with the development of communication technology and the growing popularity of electronic apparatuses, efforts are continuously being made to maintain communication security between the electronic apparatuses. Accordingly, encryption/decryption technology is used in most communication environments.

If a message encrypted by the encryption technology is transmitted to the other party, the other party may be required to perform decryption to use the message. In this case, the other party may waste resources and time in a process of decrypting the encrypted data. In addition, the message may be easily leaked to a third party if the message temporarily decrypted by the other party for its operation is hacked by the third party.

A homomorphic encryption method is being studied to solve this problem. The homomorphic encryption method may acquire the same result as an encrypted value acquired after operating on a plaintext, even if the cipher text itself is operated on without decrypting encrypted information. Therefore, various operations may be performed without decrypting the cipher text.

Recently, there are cases where it is necessary to perform an operation using a plurality of electronic apparatuses together in addition to an operation using only one electronic apparatus. For example, assume that it is necessary to integrate data from a plurality of users and compute the integrated data, such as federated learning in machine learning. If homomorphic encryption is used in this environment, the user may typically need to implement a complex multiparty computation (MPC) protocol to generate common encryption and computation keys.

Here, multiparty computation (MPC) indicates computing a function f for a specific input x₁, . . . , and xₙ together without revealing any information other than a desired output to each other.

Existing MPC may only perform the decryption if a certain quorum of users participants, and has difficulty in having to perform a protocol to generate the keys for all the participating users each time a new user is added or an existing user is deleted.

### SUMMARY

Embodiments of the present disclosure may address at least one of the issues and/or disadvantages described above and provide advantages described below. Accordingly, the present disclosure provides a method for processing a homomorphic ciphertext and an electronic apparatus, in which information is not leaked between respective electronic apparatuses even if the plurality of electronic apparatuses perform a specific operation together.

Additional embodiments are disclosed in the detailed description provided below, some of which will be obvious from the detailed description, and the others may also be suggested through learning from the disclosed embodiments.

According to an embodiment of the present disclosure, provided is an electronic apparatus. The apparatus includes: a communication device, a memory storing a first secret key and a first public key corresponding to the first secret key, and storing at least one instruction, and a processor configured to execute the at least one instruction, wherein the processor is configured to generate a switching key based on a second public key and the first secret key if the processor receives the second public key from a terminal device corresponding to a first user, and control the communication device to transmit the first public key to the terminal device, the switching key being a key that enables a homomorphic ciphertext encrypted using the first public key to be decrypted using a second secret key corresponding to the second public key, and being generated using a modulus P that is coprime to a modulus Q of the second public key, the first secret key, and the second public key.

The modulus P may be greater than the modulus Q of the second public key.

The processor may be configured to receive the second public key from each of the plurality of terminal devices, and generate the plurality of switching keys respectively corresponding to the received plurality of second public keys.

The processor may be configured to generate the first public key based on the first secret key, and store the first secret key in a secure region of the memory to prevent the first secret key from being externally leaked from the electronic apparatus.

The processor may be configured to generate a first operation key based on the first secret key, and control the communication device to provide the first operation key to a first server device performing a homomorphic operation on a plurality of homomorphic ciphertexts.

The processor may be configured to control the communication device to transmit the switching key to a second server device providing a homomorphic operation result of the first server device to each electronic apparatus.

The processor may be configured to generate a first partial secret key and a second partial secret key that satisfy mutual linearity based on the first secret key.

According to an embodiment of the present disclosure, provided is a method for controlling an electronic apparatus, the method including: storing a first secret key and a first public key corresponding to the first secret key; receiving a second public key from a terminal device corresponding to a first user; generating a switching key based on the second public key and the first secret key; and transmitting the first public key to the terminal device, wherein the switching key is a key that enables a homomorphic ciphertext encrypted using the first public key to be decrypted using a second secret key corresponding to the second public key, and is generated using a modulus P that is coprime to a modulus Q of the second public key, the first secret key, and the second public key.

The modulus P may be greater than the modulus Q of the second public key.

In the receiving of the second public key, the second public key may be received from each of the plurality of terminal devices, and in the generating of the switching key, the plurality of switching keys respectively corresponding to the received plurality of second public keys may be generated.

The method may further include: generating the first public key based on the first secret key; and storing the first secret key in a secure region of a memory to prevent the first secret key from being externally leaked from the electronic apparatus.

The method may further include: generating a first operation key based on the first secret key; and providing the first operation key to a first server device performing a homomorphic operation on a plurality of homomorphic ciphertexts.

The method may further include transmitting the switching key to a second server device providing a homomorphic operation result of the first server device to each electronic apparatus.

The method may further include generating a first partial secret key and a second partial secret key that satisfy mutual linearity based on the first secret key.

According to an embodiment of the present disclosure, provided is a non-transitory computer-readable recording medium storing a program for executing a method for controlling an electronic apparatus, wherein the method includes storing a first secret key and a first public key corresponding to the first secret key, receiving a second public key from a terminal device corresponding to a first user, generating a switching key based on the second public key and the first secret key, and transmitting the first public key to the terminal device, wherein the switching key is a key that enables a homomorphic ciphertext encrypted using the first public key to be decrypted using a second secret key corresponding to the second public key, and is generated using a modulus P that is coprime to a modulus Q of the second public key, the first secret key, and the second public key.

### BRIEF DESCRIPTION OF THE DRAWINGS

The above or other aspects, features, or benefits of embodiments in the present disclosure will be more apparent by the description provided below with reference to the accompanying drawings, in which:

FIG. 1 is a diagram for describing a structure of a network system according to an embodiment of the present disclosure;

FIG. 2 is a diagram for describing a switching key distribution operation according to an embodiment of the present disclosure;

FIG. 3 is a diagram for describing a switching key distribution operation according to an embodiment of the present disclosure;

FIG. 4 is a diagram for describing a switching key distribution operation according to an embodiment of the present disclosure;

FIG. 5 is a diagram for describing a switching key distribution operation according to an embodiment of the present disclosure;

FIG. 6 is a block diagram showing a configuration of an electronic apparatus according to an embodiment of the present disclosure;

FIG. 7 is a block diagram showing a configuration of the electronic apparatus according to an embodiment of the present disclosure;

FIG. 8 is a flow chart for describing an operation for controlling an electronic apparatus according to an embodiment of the present disclosure;

FIG. 9 is a flow chart for describing an operation for controlling a terminal device according to an embodiment of the present disclosure;

FIG. 10 is a flow chart for describing an operation for controlling a server device according to an embodiment of the present disclosure;

FIG. 11 is a flow chart for describing an operation for controlling a server device according to an embodiment of the present disclosure.

### DETAILED DESCRIPTION

The present disclosure may be variously modified and have several embodiments, and specific embodiments of the present disclosure are thus shown in the drawings and described in detail in the detailed description. However, it should be understood that the scope of the present disclosure is not limited to the specific embodiments, and include various modifications, equivalents, and/or alternatives according to the embodiments of the present disclosure. Throughout the accompanying drawings, similar components are denoted by similar reference numerals.

In describing the present disclosure, if it is decided that detailed descriptions of the known functions or configurations related to the present disclosure may unnecessarily obscure the gist of the present disclosure, the detailed descriptions thereof are omitted.

In addition, the following embodiments may be modified in several different forms, and the scope and spirit of the present disclosure are not limited to the following embodiments. Rather, these embodiments make the present disclosure thorough and complete, and are provided to fully convey the spirit of the present disclosure to those skilled in the art.

Terms used in the present disclosure are used only to describe the specific embodiments rather than limit the scope of the present disclosure. A term of a singular number includes its plural number unless explicitly interpreted otherwise in context.

In the present disclosure, expression “have”, “may have,” “include”, “may include”, or the like indicates the presence of a corresponding feature (for example, a numerical value, a function, an operation, or a component such as a part), and do not exclude the presence of an additional feature.

In the present disclosure, the expression “A or B,” “least one of A and/or B” or “one or more of A and/or B” or the like, may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions “first”, “second”, and the like used in the present disclosure may indicate various components regardless of the sequence and/or importance of the components. These expressions are only used to distinguish one component and another component from each other, and do not limit the corresponding components.

If any component (for example, a first component) is mentioned to be “(operatively or communicatively) coupled with/to” or “connected to” another component (for example, a second component), it should be understood that any component is directly coupled to another component or coupled to another component through still another component (for example, a third component).

On the other hand, if a component (for example, the first component) is mentioned to be “directly coupled to” or “directly connected to” another component (for example, the second component), it should be understood that still another component (for example, the third component) is not present between the component and another component.

An expression “configured (or set) to” used in the present disclosure may be replaced with an expression “suitable for”, “having the capacity to”, “designed to”, “adapted to”, “made to”, or “capable of” based on a context. A term “configured (or set) to” may not necessarily mean “specifically designed to” in hardware.

Rather, an expression “a device configured to” in some contexts may indicate that the device may “perform-” together with another device or component. For example, “a processor configured (or set) to perform A, B and C” may indicate a dedicated processor (for example, an embedded processor) for performing the corresponding operations or a generic-purpose processor (for example, a central processing unit (CPU) or an application processor) that may perform the corresponding operations by executing one or more software programs stored in a memory device.

In the embodiments, a “module” or a “˜er/or” may perform at least one function or operation, and be implemented in hardware or software, or be implemented by a combination of hardware and software. In addition, a plurality of “modules” or a plurality of “˜ers/ors” may be integrated with each other in at least one module and implemented by at least one processor except for a “module” or an “˜er/or” that needs to be implemented in specific hardware.

Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Meanwhile, various elements and regions in the drawings are schematically shown. Therefore, the spirit of the present disclosure is not limited by relative sizes or intervals shown in the accompanying drawings.

Meanwhile, an electronic apparatus according to the various embodiments of the present disclosure may include, for example, at least one of a smartphone, a tablet personal computer (PC), a desktop PC, a laptop PC, or a wearable device. The wearable device may include at least one of an accessory type (for example, a watch, a ring, a bracelet, an anklet, a necklace, a pair of glasses, a contact lens, or a head-mounted-device (HMD)), a textile or clothing integral type (for example, an electronic clothing), a body attachment type (for example, a skin pad or a tattoo), or a living body implantation type circuit.

In some embodiments, the electronic apparatus may include, for example, at least one of a television, a digital video disk (DVD) player, an audio player, a refrigerator, an air conditioner, a vacuum cleaner, an oven, a microwave oven, a washing machine, an air purifier, a set-top box, a home automation control panel, a security control panel, a media box, a game console, an electronic dictionary, an electronic key, a camcorder, or an electronic picture frame. Meanwhile, among the electronic apparatuses described above, a device equipped with a display may be referred to as a display device. Meanwhile, the electronic apparatus in the present disclosure may be a set-top box or a PC that provides an image to the display device even without including any display.

In addition, in the present disclosure, a “value” may be defined as a concept that includes a vector as well as a scalar value. In addition, in the present disclosure, an expression such as “calculate” or “compute” may be replaced with an expression of generating a result of the corresponding calculation or computation. In addition, an operation on a ciphertext described below may indicate homomorphic operation unless otherwise indicated. For example, addition of homomorphic ciphertexts indicates homomorphic addition for the two homomorphic ciphertexts.

Mathematical operations and calculations in each step of the present disclosure described below may be implemented as computer operations by a known coding method and/or coding designed to be suitable for the present disclosure to perform the corresponding operations or calculations.

Specific equations described below are described as examples among possible alternatives, and the scope of the present disclosure should not be construed as being limited to the equations mentioned in the present disclosure.

For convenience of description, the present disclosure defines the following notations:
a←D: Select an element based on a distribution D.
s₁, s₂∈R: Each of s₁ and s₂ is an element belonging to a set R.
mod(q): Perform modular operation using an element q.
└⋅┐: Round an internal value.

Hereinafter, the embodiments of the present disclosure are described in detail with reference to the accompanying drawings so that those skilled in the art to which the present disclosure pertains may easily practice the present disclosure.

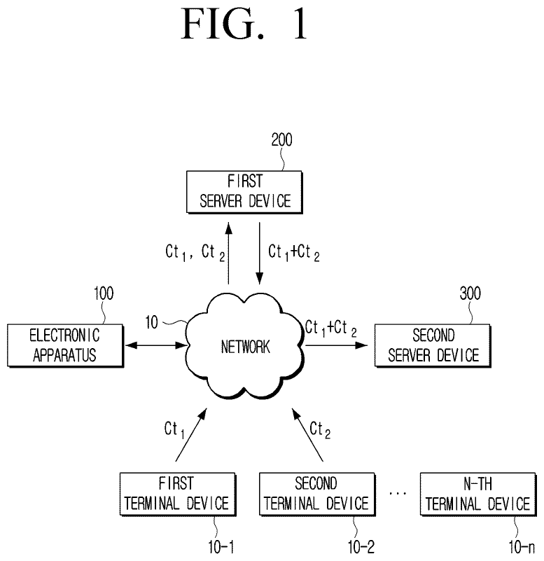

FIG. 1 is a diagram for describing a structure of a network system according to an embodiment of the present disclosure.

Referring to FIG. 1, the network system may include an electronic apparatus 100, a plurality of terminal devices 10-1, 10-2, . . . , and 10-n, a first server device 200, and a second server device 300.

The plurality of devices may be connected to each other via a network 20. The network 20 may be implemented in any of various types of wired and wireless communication networks, a broadcast communication network, an optical communication network, a cloud network, or the like, and the respective devices may be connected to each other in a way such as wireless fidelity (Wi-Fi), Bluetooth, or near field communication (NFC) without a separate medium.

The electronic apparatus 100 may generate a secret key (hereinafter, a first secret key) and a public key (hereinafter, a first public key) to be used by the first server device 200. Here, the secret key is a key used to decrypt a homomorphic ciphertext, and the public key is a key used to encrypt the homomorphic ciphertext. This secret key may be referred to as a server secret key or a server key, and the public key may be referred to as a server public key, a server encryption key, or the like.

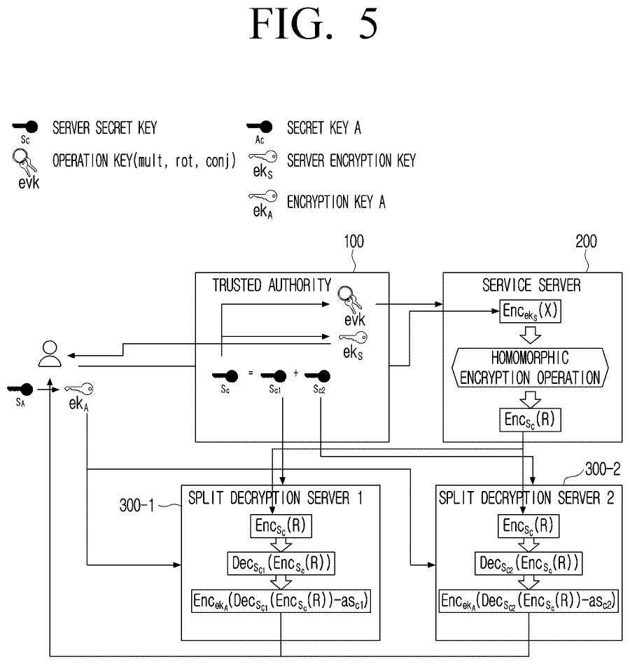

Here, the electronic apparatus 100 may generate a first partial secret key and a second partial secret key that satisfy mutual linearity based on the first secret key. An embodiment of using the partial secret key is described below with reference to FIG. 5.

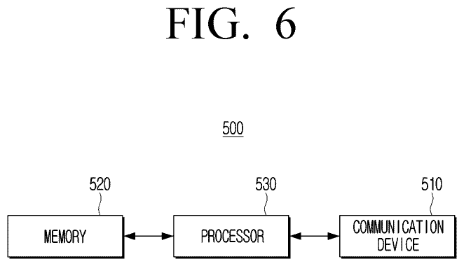

In addition, the electronic apparatus 100 may also generate an operation key used for a specific homomorphic operation. A detailed key generation method is described below with reference to FIG. 6.

The electronic apparatus 100 may receive the public key (hereinafter, a second public key) from each of the terminal devices 10-1, 10-2, . . . , and 10-n, and use the same to generate a switching key. The public key received here may be different for each terminal device, and the switching key generated accordingly may also be different.

In case of using a public key encryption method, the homomorphic ciphertext encrypted using a specific public key may be decrypted using a secret key corresponding thereto. That is, the specific secret key and the specific public key may be paired. However, the switching key is a key that enables an encryption key of the homomorphic ciphertext to be changed using the first public key to allow the homomorphic ciphertext to be decrypted using a second secret key instead of the first secret key. This switching key may also be referred to as a conversion key.

The key conversion operation may be referred to as key switching, and is a technique widely used in the homomorphic encryption, and the present disclosure does not describe the corresponding method in detail.

If the various keys are generated or prepared, the electronic apparatus 100 may provide the first public key to each of the terminal devices 10-1, 10-2, . . . , and 10-n, the operation key to the first server device 200, and the switching key to the second server device 300.

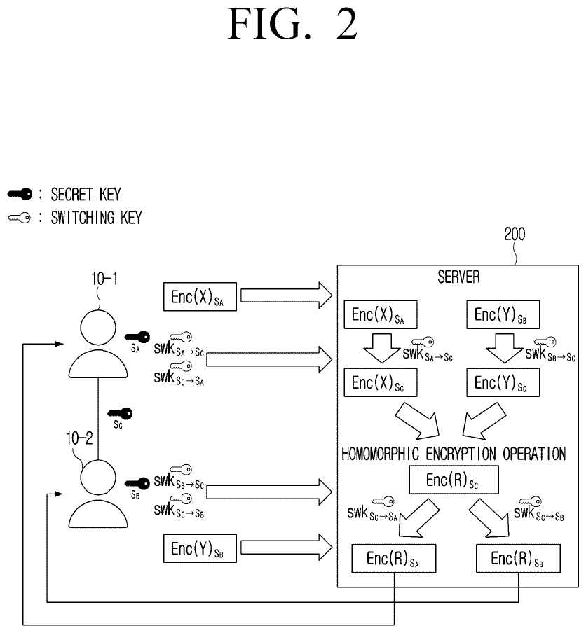

A main purpose of such an electronic apparatus is to generate a key used for a homomorphic operation, and may thus also be referred to as a key generation device or key generator. The specific configuration and operation of the electronic apparatus 100 are described below with reference to FIGS. 2 to 4.

The terminal devices 10-1, 10-2, . . . , and 10-n may each generate the second secret key and the second public key, and transmit the generated second public key to the electronic apparatus 100. Hereinabove, the term “terminal device” is used to distinguish the corresponding device from the electronic apparatus. However, the terminal device may also be referred to as the electronic apparatus, and may be referred to as a user terminal device, a user device, a smartphone, a personal terminal, or the like.

The terminal devices 10-1, 10-2, . . . , and 10-n may each receive the first public key from the electronic apparatus 100, and perform the homomorphic encryption on data by using the received first public key to thus generate the homomorphic ciphertext.

The terminal devices 10-1, 10-2, . . . , and 10-n may each transmit the generated homomorphic ciphertext to the first server device 200. Meanwhile, the illustrated example shows that each terminal device directly transmits the generated homomorphic ciphertext to the first server device 200. However, in implementation, the terminal device may transmit the generated homomorphic ciphertext to the first server device via another device, and a specific terminal device may collect the generated homomorphic ciphertexts and then transmit the same to the first server device.

Meanwhile, the illustrated drawing shows that the plurality of terminal devices 10-1 to 10-n are used. However, the plurality of electronic apparatuses may not necessarily be required, and a single apparatus may be used instead. For example, the terminal devices 10-1 to 10-n may be implemented in various types of devices such as smartphones, tablets, game players, personal computers (PCs), laptop PCs, home servers, or kiosks, and may also be implemented in other types of home appliances each having an internet of things (IoT) function.

A user may input various information through the terminal devices 10-1 to 10-n used by the user. The input information may be stored in the terminal devices 10-1 to 10-n themselves, and may also be transmitted and stored in an external device for storage capacity, a security reason, or the like.

For example, the terminal device 10-1 to 10-n may each perform the operation based on information provided by the first server device 200 and provide an operation result to the first server device 200. That is, each of the electronic apparatus 100-1 to 100-n may be a party (or the user) in a distributed computation system included in a multiparty computation system.

Here, each terminal device may be a database of a specific hospital, and the first server device may be a device that receives treatment data from each hospital and generates a machine learning model based thereon.

The first server device 200 may store the received homomorphic ciphertext in a ciphertext state without decrypting the same. In addition, the first server device 200 may perform the homomorphic operation on the homomorphic ciphertext received from each of the plurality of devices. Here, the first server device 200 may perform the homomorphic operations, including not only an arithmetic operation such as addition and multiplication between the plurality of homomorphic ciphertexts, but also a homomorphic product, a homomorphic rotation, or the like. In addition, the first server device 200 may perform various homomorphic operations on the homomorphic ciphertext in the ciphertext state by using an approximation polynomial corresponding to a specific function. If necessary, the first server device 200 may perform a reboot operation on the homomorphic ciphertext.

The first server device 200 may transmit the homomorphic operation result to the second server device 300. The homomorphic operation result may also remain as the homomorphic ciphertext. In addition, this homomorphic ciphertext may be decrypted using the first secret key.

The second server device 300 may receive information on the terminal device and the switching key corresponding thereto from the electronic apparatus 100. In addition, the second server device 300 may perform the key switching using the received switching key in case of receiving the homomorphic ciphertext from the first server device 200, and may transmit the key-switched homomorphic ciphertext to the terminal device corresponding to the used switching key.

For example, if the homomorphic ciphertext is key-switched using a first switching key corresponding to the first terminal device 10-1, the corresponding homomorphic ciphertext may be decrypted only using the secret key of the first terminal device 10-1 corresponding to the first switching key. Therefore, the second server device 300 may transmit the homomorphic ciphertext, key-switched using the corresponding switching key, to the first terminal device 10-1. Meanwhile, even if the corresponding key-switched homomorphic ciphertext is transmitted to another terminal device 10-2 or the external device due to a transmission error, the corresponding ciphertext remains secure because its decryption is impossible without the second secret key of the first terminal device 10-1.

Each of the terminal devices 10-1, . . . , and 10-n may receive the homomorphic ciphertext from the second server device 300. Here, each of the terminal devices 10-1, . . . , and 10-n may receive the homomorphic ciphertext, key-switched using the switching key corresponding to each of the terminal devices, from the second server device 300, and thus may perform the decryption on the received homomorphic ciphertext by using its own secret key.

Meanwhile, in describing the present disclosure with reference to FIG. 1, the separate server devices are shown and described as performing the homomorphic operation and the switching key application, respectively. However, in implementation, a single device may perform these operations. In addition, the function of the electronic apparatus may be combined with the function of the first server device, or the function of the electronic apparatus may be combined with the function of the second server device.

As described above, the network system according to the present disclosure may be operated while ensuring low complexity and high security because each terminal device is operated using the homomorphic ciphertext encrypted using the same key during a homomorphic operation process while each terminal device may decrypt the ciphertext using a different secret key even if the plurality of terminal devices cooperate to perform the operation.

FIG. 2 is a diagram for describing a switching key distribution operation according to an embodiment of the present disclosure. For example, FIG. 2 is a diagram for describing an embodiment in which multiple terminal devices perform a common service operation using the switching key.

In detail, if the multiple terminal devices encrypt using different keys, the resulting homomorphic ciphertexts may be encrypted using the different keys, thus making the homomorphic operation difficult.

If the multiple terminal devices use the same key to avoid this difficulty, the key may be shared among these terminal devices. Accordingly, a first user may easily decrypt a ciphertext of a second user and check the content. The switching key may be used to solve this problem.

Referring to FIG. 2, the server device 200 may generate a server secret key S_{C} to be used by the server and provide the generated secret key S_{C} to each of the terminal devices 10-1 and 10-2.

Each of the terminal devices 10-1 and 10-2 may generate a first switching key S_{A}->S_{C}, a second switching key S_{B}->S_{C}, a third switching key S_{C}->S_{A}, and a fourth switching key S_{C}->S_{B} by using its own secret key S_{A} or S_{B} and the server secret key S_{C}. Here, the first and third switching keys may be the switching keys corresponding to the first user (or the first terminal device), and the second and fourth switching keys may be the switching keys corresponding to the second user (or a second terminal device).

In addition, each of the terminal devices 10-1 and 10-2 may provide the generated switching key to the server device 200.

Accordingly, the server device 200 may convert each of the homomorphic ciphertexts provided by each of the terminal devices into the ciphertexts, decryptable using the server secret key S_{C}, by using the switching key. For example, the server device 200 may convert a first ciphertext Enc(X)_{S}_{_{A}} provided by the first terminal device 10-1 into a ciphertext Enc(X)_{S}_{_{C}}, decryptable using the server secret key S_{C}, by using the first switching key S_{A}->S_{C}.

In addition, the server device 200 may convert a second ciphertext Enc(Y)_{S}_{_{B}} provided by the second terminal device 10-2 into a ciphertext Enc(Y)_{S}_{_{C}}, decryptable using the server secret key S_{C}, by using the second switching key S_{B}->S_{C}.

If the ciphertext decryptable using the server secret key is prepared in this way, the server device 200 may perform various homomorphic operations by using the corresponding ciphertext.

In addition, if it is necessary to provide the corresponding homomorphic operation result to each of the terminal devices, the server device 200 may perform the key switching operation by using the switching key corresponding to each of the terminal devices. For example, the server device 200 may convert a ciphertext Enc(R)_{S}_{_{C}}, which is the homomorphic operation result, into a ciphertext Enc(R)_{S}_{_{A}}, decryptable using the first secret key S_{A}, by using the third switching key S_{C}->S_{A}.

In addition, the server device 200 may transmit the ciphertext Enc(R)_{S}_{_{A}} to the first terminal device 10-1. Accordingly, the first terminal device 10-1 may decrypt the received homomorphic ciphertext Enc(R)_{S}_{_{A}} by using the first secret key S_{A} held by the device.

In addition, the server device 200 may convert the ciphertext Enc(R)_{S}_{_{C}}, which is the homomorphic operation result, into a ciphertext Enc(R)_{S}_{_{B}}, decryptable using the second secret key S_{B}, by using the fourth switching key S_{C}->S_{B}.

In addition, the server device 200 may transmit the ciphertext Enc(R)_{S}_{_{B}} to the second terminal device 10-2. Accordingly, the second terminal device 10-2 may decrypt the received homomorphic ciphertext Enc(R)_{S}_{_{B}} by using the second secret key S_{B} held by the second terminal device 10-2.

In this way, as shown in the embodiment of FIG. 2, each of the terminal devices may be operated using a different secret key. Therefore, it is difficult for the terminal device to decrypt the homomorphic ciphertext of another terminal device even if the terminal device acquires the corresponding homomorphic ciphertext.

However, if the terminal device acquires the switching key of another terminal device, the terminal device may decrypt the ciphertext of another terminal device. For example, if the second terminal device 10-2 acquires the first switching key of the first terminal device, the second terminal device 10-2 may key-switch the homomorphic ciphertext of the first terminal device to the homomorphic ciphertext decryptable using the server key, and then convert the corresponding homomorphic ciphertext again to the fourth switching key held by the device. Accordingly, the homomorphic ciphertext may be decrypted using the secret key of the second terminal device.

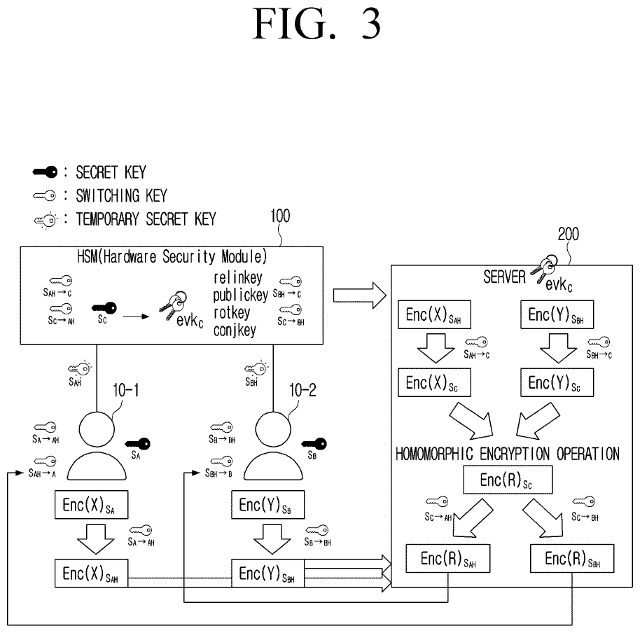

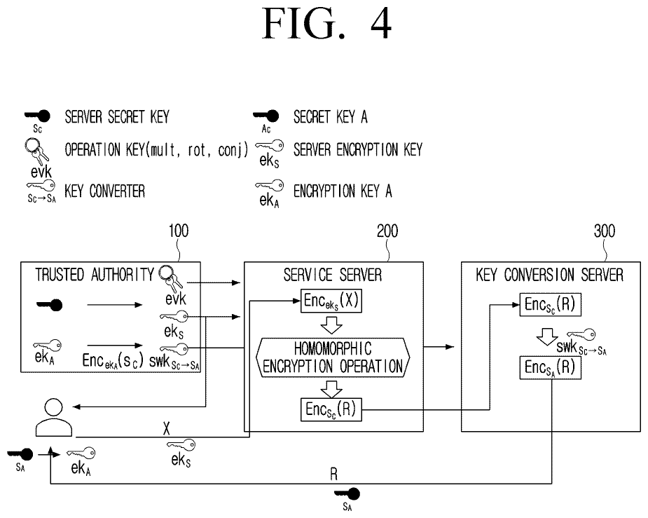

Hereinafter, an additional embodiment for solving the above-described problem is described with reference to FIGS. 3 and 4.

FIG. 3 is a diagram for describing a switching key distribution operation according to an embodiment of the present disclosure.

Referring to FIG. 3, the system may include the plurality of terminal devices 10-1 and 10-2, the electronic apparatus 100, and the server device 200.

The electronic apparatus 100 may generate the first secret key S_{C} and the first public key corresponding thereto. In addition, if the first terminal device 10-1 requests to subscribe to a service provided by the server device 200, the electronic apparatus 100 may generate a temporary shared key between the first terminal device 10-1 and the server device 200 and share the generated temporary shared key with the first terminal device 10-1. The temporary shared key is referred to as S_{AH}.

In addition, the electronic apparatus 100 may generate a switching key evk_{S}_{_{AH}}_{→S}_{_{C}} or evk_{S}_{_{C}}_{→S}_{_{AH}} between the first secret key S_{C} and the temporary shared key S_{AH}.

The electronic apparatus 100 may provide the temporary shared key S_{AH} to the first terminal device 10-1, and the first terminal device 10-1 may generate a temporary switching key evk_{S}_{_{AH}}_{→S}_{_{A}} or evk_{S}_{_{A}}_{→S}_{_{AH}} by using the corresponding temporary shared key.

Another terminal device 10-2 may also perform the same operation.

The electronic apparatus 100 may then discard the temporary shared key S_{AH} or S_{BH} and transmit the switching key evk_{S}_{_{AH}}_{→S}_{_{C}}, evk_{S}_{_{C}}_{→S}_{_{AH}}, evk_{S}_{_{AH}}_{→S}_{_{A}}, or evk_{S}_{_{A}}_{→S}_{_{AH}} to the server device 200.

Each of the terminal devices 10-1 and 10-2 may generate the homomorphic ciphertext by using its own public key (or encryption key).

In addition, each of the terminal devices 10-1 and 10-2 may key-switch the corresponding homomorphic ciphertext Enc(X)_{S}_{_{A}} or Enc(Y)_{S}_{_{B}} by using the received intermediate switching key and transmit a key-switching result Enc(X)_{S}_{_{AH}} or Enc(Y)_{S}_{_{BH}} to the server device 200.

In addition, the server device 200 may convert the first ciphertext Enc(X)_{S}_{_{AH}} received from the first terminal device 10-1 into the ciphertext Enc(X)_{S}_{_{C}}, decryptable using the server secret key, by using another intermediate switching key S_{AH}->S_{C}.

In addition, the server device 200 may convert the second ciphertext Enc(Y)_{S}_{_{BH}} received from the second terminal device 10-2 into the ciphertext Enc(Y)_{S}_{_{C}}, decryptable using the server secret key, by using another intermediate switching key S_{BH}->S_{C}.

If the ciphertext decryptable using the server secret key is prepared in this way, the server device 200 may perform the various homomorphic operations by using the corresponding ciphertext.

In addition, if it is necessary to provide the corresponding homomorphic operation result to each of the terminal devices, the server device 200 may key-switch the operation result by using the switching key corresponding to each of the terminal devices.

For example, the server device 200 may convert the ciphertext Enc(R)_{S}_{_{C}}, which is the homomorphic operation result, into the ciphertext Enc(R)_{S}_{_{AH}}, by using the third switching key S_{C}->S_{AH}.

In addition, the server device 200 may transmit the corresponding ciphertext Enc(R)_{S}_{_{A}} to the first terminal device 10-1. Accordingly, the first terminal device 10-1 may convert the received ciphertext into the homomorphic ciphertext by using the temporary switching key held by the device. In addition, the first terminal device 10-1 may decrypt the received homomorphic ciphertext Enc(R)_{S}_{_{A}} by using the first secret key S_{A}.

In this way, the first terminal device does not need to disclose its own secret key, and in addition, the server secret key may not be directly used and therefore not be disclosed.

Meanwhile, the electronic apparatus may distribute the encryption key to a specific third terminal device to generate the homomorphic ciphertext. In this case, the third terminal device is unable to decrypt the homomorphic ciphertext although the third terminal device may generate the homomorphic ciphertext and perform the homomorphic operation by using the corresponding encryption key.

Meanwhile, the electronic apparatus, the server, and the terminal devices are described above under the assumption that the devices are operated on the same encryption scheme (e.g., Cheon-Kim-Kim-Song (CKKS) encryption scheme). However, in implementation, the scheme used by each device may differ. In this case, the process of applying the switching key described above may also further include a process of converting the scheme, in addition to the process of changing the encryption key.

FIG. 4 is a diagram for describing a switching key distribution operation according to an embodiment of the present disclosure.

Referring to FIG. 4, the system may include the terminal device 10-1, the electronic apparatus 100, the first server device 200, and the second server device 300.

The electronic apparatus 100 may store the first secret key S_{C} and a first public key ek_{S}. In addition, the electronic apparatus 100 may generate a set of an operation keys or evaluation keys (a.k.a evk) by using the first secret key S_{C} in response to the generation of the above-described secret key and the public key.

In addition, the electronic apparatus 100 may receive a second public key ek_{A} from the first terminal device 10-1 corresponding to the first user. Here, the second public key ek_{A} may be the public key corresponding to the second secret key S_{A} generated by the first user (or the first terminal device). For example, the electronic apparatus may receive the second public key ek_{A} from the terminal device (or the user) corresponding to the first user. If the multiple terminal devices participate in the homomorphic operation or homomorphic computation, the plurality of second public keys may be received from the plurality of terminal devices, respectively.

In addition, the electronic apparatus 100 may generate the switching key by using the second public key ek_{A}. For example, the electronic apparatus 100 may generate a switching key swk_{S}_{_{C}}_{→S}_{_{A}} by using a modulus P that is coprime to a modulus Q of the second public key, the first secret key S_{C} and the second public key ek_{A}. The switching key is a key that allows the homomorphic ciphertext encrypted using the first public key to be decrypted using the second secret key corresponding to the second public key. In this case, the modulus P may be larger than the modulus Q of the second public key.

For example, if the electronic apparatus 100 receives the second public key ek_{A} from the first terminal device, the electronic apparatus 100 may encrypt P_{SC}, which is multiplication of the server secret key S_{S} and a large modulus P, by using the corresponding second public key ek_{A}. This value is equal to Encₑₖ_{_{A}}(S_{C})=swk_{S}_{_{C}}_{→S}_{_{A}}, and the electronic apparatus 100 may convert the homomorphic ciphertext decryptable using the server secret key into the homomorphic ciphertext decryptable using a first user secret key, by using this conversion key.

Upon examining this process in the CKKS scheme, to acquire the key conversion key of type swk_{S}_{_{C}}_{→S}_{_{A}}=(a′s_{A}+Ps_{C}+e′,a′), the following process may be performed using the public key of a user A.

$${ek}_{A} = ( - {as}_{A} + e , a ) \\ {Enc}_{{ek}_{A}} ( {s}_{C} ) = ( ( - {as}_{A} + e ) v + {e}_{2} + {Ps}_{c} av + {e}_{1} ) = {swk}_{{S}_{c} \to {S}_{A}} .$$

If the switching key swk_{S}_{_{C}}_{→S}_{_{A}} is generated in this way, the electronic apparatus 100 may transmit the generated switching key to the second server device 300, the first public key to the first terminal device 10-1, and the operation keys evk to the first server device 200 that performs the homomorphic operation.

The first terminal device 10-1 may generate the second secret key S_{A} and the second public key ek_{A}. In addition, the first terminal device 10-1 may transmit the second public key ek_{A} to the electronic apparatus 100 for the generation of the switching key.

In addition, the first terminal device 10-1 may receive the first public key ek_{S} from the electronic apparatus. Here, the first public key may be the public key corresponding to the first secret key of the server, and differ from the second public key generated by the terminal device.

If the first public key ek_{S} is received in this way, the terminal device 10-1 may generate the homomorphic ciphertext based on a message and the first public key ek_{S}. If the homomorphic ciphertext is generated, the terminal device 10-1 may transmit the generated homomorphic ciphertext to the first server device 200.

The first server device 200 may receive the operation keys evk from the electronic apparatus 100. In addition, the first server device 200 may receive the homomorphic ciphertext from the terminal device 10-1. The homomorphic ciphertext may be a ciphertext homomorphically encrypted using the first public key ek_{S}.

Accordingly, the first server device 200 may perform the various operations on the homomorphic ciphertext by using the operation keys evk. Here, the first server device 200 may perform the operations, including not only the arithmetic operations such as homomorphic addition, homomorphic multiplication, or homomorphic division, but also the various operations by using the approximation polynomial.

In addition, if the specific operation is completed, the first server device 200 may provide an operation result Enc_{S}_{_{C}}(R) to the second server device 300.

The second server device 300 may receive the switching key swk_{S}_{_{C}}_{→S}_{_{A}} from the electronic apparatus 100. In addition, the second server device may receive the operation result Enc_{S}_{_{C}}(R) from the first server device 200.

The second server device 300 may determine the terminal device 10-1 to receive the operation result, and key-switch the operation result by using the switching key swk_{S}_{_{C}}_{→S}_{_{A}} corresponding to the determined terminal device 10-1. For example, the second server device 300 may key-switch the homomorphic ciphertext Enc_{S}_{_{C}}(R), decryptable using the first secret key S_{C}, by using the first switching key swk_{S}_{_{C}}_{→S}_{_{A}} decryptable using the second secret key S_{A} of the first terminal device.

In addition, the second server device 300 may transmit the key-switched homomorphic ciphertext Enc_{S}_{_{A}}(R) to the terminal device 10-1. For example, the second server device 300 may transmit the homomorphic ciphertext key-switched using the first switching key to the first terminal device corresponding to the first switching key, and the homomorphic ciphertext key-switched using the second switching key to the second terminal device corresponding to the second switching key.

The terminal device 10-1 may receive the operation result Enc_{S}_{_{A}}(R) of the homomorphic operation from the second server device 300. Here, the received homomorphic ciphertext may be the homomorphic ciphertext decryptable using the second secret key S_{A}.

Accordingly, the terminal device may decrypt the received homomorphic ciphertext Enc_{S}_{_{A}}(R) by using the pre-stored second secret key S_{A}.

According to an embodiment as shown in FIG. 4, the terminal device may not hold the server secret key. Accordingly, as described with reference to FIG. 2, this configuration may prevent the problem that may occur due to each terminal device holding the server secret key. In addition, as described with reference to FIG. 4, the different servers may perform the function of performing the homomorphic operation and the function of performing the key switching separately, thereby reducing a risk of collusion between the user and the server.

In addition, the reliable electronic apparatus may only perform the key generation task, while another device may perform the homomorphic operation, the key switching, or the like, thereby reducing a bottleneck phenomenon caused by the task performance.

FIG. 5 is a diagram for describing a switching key distribution operation according to an embodiment of the present disclosure. In detail, FIG. 5 is a diagram for describing an example of decrypting the homomorphic ciphertext by using multi party computation (MPC).

Referring to FIG. 5, the system may include the terminal device 10-1, the electronic apparatus 100, the first server device 200, a second server device 300-1, and a third server device 300-2.

The electronic apparatus 100 may store the first secret key S_{C} and the first public key ek_{S}. In addition, the electronic apparatus 100 may generate the operation key evk used for the specific homomorphic operation by using the above-described secret key S_{C}.

Meanwhile, in case of using the switching key as shown in the example of FIG. 4, it is necessary to maintain a high level of security of the key conversion server to ensure its safety. That is, the electronic apparatus 100 may apply the MPC function to a decryption function process to enhance the security.

For the MPC decryption in the homomorphic encryption system, the electronic apparatus 100 may split the secret key and distribute each split key to the plurality of decryption servers. For example, the electronic apparatus 100 may split the generated secret key S_{C} into the plurality of keys satisfying the linearity such as S_{c}=S_{c1}+S_{c2}. In addition, the electronic apparatus 100 may transmit the split secret keys to the different server devices 300-1 and 300-2, respectively. Hereinafter, the keys split linearly in this manner are referred to as partial secret keys S_{c1} and S_{c2}. The present disclosure gives an example of splitting the secret key into two. However, in implementation, the secret key may be split into three or more.

The electronic apparatus 100 may provide the first public key ek_{S} to the first terminal device 10-1. In addition, the electronic apparatus 100 may transmit the generated operation keys evk to the first server device 200.

The first terminal device 10-1 may generate the second secret key S_{A} and the second public key ek_{A}. In addition, the first terminal device 10-1 may receive the first public key ek_{S} from the electronic apparatus 100. Here, the first public key may be the public key corresponding to the first secret key of the server, and differ from the second public key generated by the first terminal device.

In addition, the first terminal device 10-1 may transmit the generated second public key ek_{A} to the second server device 300-1 and the third server device 300-2.

The first terminal device 10-1 may homomorphically encrypt a message X by using the first public key ek_{S} and transmit a homomorphically encrypted ciphertext Encₑₖₛ(X) to the first server device 200.

The first server device 200 may receive the operation keys evk from the electronic apparatus 100. In addition, the first server device 200 may receive the homomorphic ciphertext from the terminal device. The homomorphic ciphertext may be a ciphertext homomorphically encrypted using the first public key.

Accordingly, the first server device 200 may perform the various operations on the homomorphic ciphertext by using the operation keys evk. In case of completing the specific operation, the first server device 200 may provide the operation result Enc_{S}_{_{C}}(R) to the second server device 300-1 and the third server device 300-2. Here, the second server device 300-1 and the third server device 300-2 may be referred to as split decryption servers.

The second server device 300-1 and the third server device 300-2 may each receive the second public key ek_{A} from the first terminal device 10-1. The second server device 300-1 and the third server device 300-2 may receive the partial secret keys S_{c1} and S_{c2} from the electronic apparatus 100, respectively. Here, the two devices may receive the different partial secret keys. For example, the second server device 300-1 may receive the first partial secret key S_{c1} from the electronic apparatus 100. In addition, the third server device 300-2 may receive the second partial secret key S_{c2} from the electronic apparatus 100.

In addition, the second server device 300-1 and the third server device 300-2 may each receive the operation result Enc_{S}_{_{C}}(R) from the first server device 200.

In addition, the second server device 300-1 and the third server device 300-2 may each partially decrypt the received operation result by using the partial secret keys S_{c1} and S_{c2}. Instead of decrypting the corresponding ciphertext by using the first secret key, the device may partially decrypt the corresponding ciphertext by using the partial secret key. Accordingly, it is difficult for the second server device 300-1 or the third server device 300-2 to decrypt the operation result by using only a partial decryption result. In this way, the risk of collusion may be reduced through the partial decryption of the ciphertext using each secret key assigned to the split service servers.

To describe in more detail, if the first server device 200 generates an operation result ciphertext as_{c}+R+e,−a, the second server device 300-1 may generate a first partial decryption result a(s_{c1}+s_{c2})+R+e−as_{c1}=Decₛ_{_{c1}}(Encₛ_{_{c}}(R)) by using the split secret key S_{c1}. The second server device 300-1 may then additionally subtract as_{c1} from the decryption result. That is, the second server device 300-1 may generate as_{c2}+R+e−as_{c1}.

Similarly, the third server device 300-2 may also generate as_{c1}+R+e−as_{c2} by using the split secret key S_{c2}. Here, it may be seen that adding the result values of the second server device 300-1 and the third server device 300-2 results in 2R≈as_{c2}+R−as_{c1}+as_{c1}+R−as_{c2}+2e. R is not able to be acquired unless the two server devices collude.

The second server device 300-1 may homomorphically encrypt the partial decryption result as_{c2}+R+e−as_{c1} by using the second public key ek_{A} of the first terminal device 10-1, and the third server device 300-2 may homomorphically encrypt the partial decryption result as_{c1}+R+e−as_{c2} by using the second public key ek_{A} of the first terminal device 10-1.

The second server device 300-1 and the third server device 300-2 may each transmit their operation results to the first terminal device 10-1.

The first terminal device 10-1 may receive the split decryption results from the second server device 300-1 and the third server device 300-2, respectively.

The first terminal device 10-1 may perform an operation of combining the partial decryption results into one. For example, in case of ignoring small noise e for convenience, the first terminal device 10-1 may perform Enc_{S}_{_{A}}(as_{c2}+R−as_{c1}+as_{c1}+R−as_{c2})=Enc_{S}_{_{A}}(2R). R may be doubled in this combined value. Therefore, the first terminal device 10-1 may acquire a final operation result by dividing the operation result by 2 and then decrypting the result by using the second secret key S_{A}, or by performing an operation of decrypting the result by using the second secret key S_{A} and then dividing the decrypted result by 2.

The number of split decryption servers used here and the split secret keys may be generalized to n. The decryption using the MPC-based secret key splitting may reduce the risk of collusion as the number of servers is increased. However, an amount of communication may be increased proportionally to the number of servers.

FIG. 6 is a block diagram showing a configuration of an electronic apparatus according to an embodiment of the present disclosure.

In detail, the electronic apparatus may not only refer to a device generating various keys in the system of FIG. 1, but also refer to a terminal device performing the homomorphic encryption, a device operating the homomorphic ciphertext, such as the first server device, and a device performing the key switching on the homomorphic ciphertext, such as the second server device. The electronic apparatus may be any of the various devices such as a personal computer (PC), a laptop, a smartphone, a tablet, or a server.

Referring to FIG. 6, an electronic apparatus 500 may include a communication device 510, a memory 520, and a processor 530.

The communication device 510 may connect the electronic apparatus 500 to the external device (not shown), and may be connected to the external device through a local area network (LAN) or an internet network or through a universal serial bus (USB) port or a wireless communication port (for example, wireless fidelity (Wi-Fi) 802.11a/b/g/n, near field communication (NFC), or Bluetooth). The communication device 510 may also be referred to as a communication circuit or a transceiver.

The communication device 510 may receive the public key from the external device, and the electronic apparatus 500 may transmit its own generated public key to the external device. In addition, the communication device 510 may receive the various switching keys and operation keys, or transmit the received keys to the external device.

In addition, the communication device 510 may receive the message from the external device, and transmit the generated homomorphic ciphertext to the external device. On the other hand, the communication device 510 may also receive the homomorphic ciphertext from the outside.

In addition, the communication device 510 may receive various parameters necessary for generating the ciphertext from the external device.

In addition, the communication device 510 may receive a request for the operation on the homomorphic ciphertext from the external device and transmit its computation result to the external device.

The memory 520 is a component for storing an operating system (O/S), various instructions, software, data, and the like for driving the electronic apparatus 500. Here, the instruction may be an algorithm related to generating the homomorphic ciphertext, a decryption algorithm, or a reboot algorithm.

The memory 520 may be implemented in any of various forms such as a random access memory (RAM), a read-only memory (ROM), a flash memory, a hard disk drive (HDD), an external memory, or a memory card, and is not limited to any one of these forms.

The memory 520 may store the message to be encrypted. Here, the message may be various credit information, personal information, or the like, cited by the user in various ways, and may also be information on a usage history, such as location information or internet usage time information, used by the electronic apparatus 500.

In addition, the memory 520 may store the public key, and store not only the secret key but also the various parameters necessary for generating the public key and the secret key if the electronic apparatus 500 is a device that directly generates the public key.

The memory 520 may include a secure region, and store the secret key in the secure region.

In addition, the memory 520 may store the generated homomorphic ciphertext in a process described below. In addition, the memory 520 may store the homomorphic ciphertext transmitted from the external device. In addition, the memory 520 may also store the operation result ciphertext, which is a result of an operation process described below.

The processor 530 may control overall operations of the electronic apparatus 100. In detail, the processor 530 may be connected to the components of the electronic apparatus including the communication device 510 and the memory 520, and execute at least one instruction stored in the memory 520 as described above, thereby controlling the overall operations of the electronic apparatus 100. In particular, the processor 530 may be implemented as one processor or as a plurality of processors.

The processor 530 may be implemented as at least one integrated circuit (IC, or circuitry) chip and may perform various data processing. The processor 530 may include at least one electrical circuit and may individually or collectively distribute and process the instruction (or a program, data, or the like) stored in the memory.

The processor 530 may include a processor assembly including one or more processing circuits. The processor 530 may include any processing circuit operative to control the performance and operations of one or more components of the electronic apparatus (e.g., memory and/or drive device (sensor)). For example, the processor 530 (e.g., application processor (AP)) may be implemented as a system on chip (SoC) (e.g., single chip or chipset). For example, the processor 530 may be implemented with multiple cores (or at least one core circuit), multiple chips, or multiple chipsets.

For example, the processor 530 may include one or more processing circuits. In addition, the processor 530 may include one or more processing circuits configured to individually and/or collectively perform the various functions of the present disclosure. As a non-limiting example, at least a portion of the processor 530 may be included in a first chip of the electronic apparatus 100, and at least another portion of the processor 530 may be included in a second chip of the electronic apparatus that is different from the first chip of the electronic apparatus 100.

For example, the processor 530 may include a central processing unit (CPU), a graphics processing unit (GPU), a neural processing unit (NPU), an image signal processor (ISP), a display controller, a memory controller, a storage controller, a communication processor (CP), and/or a sensor interface. These components of the processor 530 are provided only as examples. The processor 530 may further include other components in addition to the components described above. In addition, some components of the processor 530 may be omitted. In addition, some components of the processor 530 may be included as separate components of the electronic apparatus 100, external to the processor 530. For example, some components of the processor 530 (e.g., memory controller) may be included in other components (for example, at least a portion of the memory, an interface (e.g., available for connection to at least one component of the electronic apparatus 100), or a display).

The processor 530 may cause other components of the electronic apparatus 500 to perform various operations by executing the instructions stored in the memory 520. The processor 530 may process a set value, a function instruction, or the like based on the pre-stored control program or control data, and output a control signal related to a function that the electronic apparatus 500 may perform or a communication signal for communication of the electronic apparatus 500 with an external electronic apparatus.

In case of receiving the message to be transmitted, the processor 530 may store the same in the memory 520. The processor 530 may homomorphically encrypt the message by using various set values and programs stored in the memory 520. In this case, the processor 530 may use the public key.

The processor 530 may generate the public key necessary to perform the encryption on its own and use the same, or may receive the public key from the external device and use the same. For example, the second server device 300 performing the decryption may distribute the public key to other devices.

In case of generating the key on its own, the processor 530 may generate the public key by using a ring-LWE scheme. To describe in detail, the processor 530 may first set the various parameters and rings and store the same in the memory 520. An example of the parameter may include a length of a plaintext message bit, a size of the public key, a size of the secret key, or the like.

The ring may be expressed using the following equation.

$$R = {Z}_{q} [ X ] / f ( x ) \qquad [ Equation 2 ]$$

Here, R indicates the ring, Z_{q} indicates a coefficient, and f(x) indicates an N-th polynomial.

The ring indicates a set of polynomials having predetermined coefficients, and indicates the set in which addition and multiplication are defined between elements and which is closed under the addition and the multiplication. The ring may be referred to as Ring.

For example, the ring indicates a set of the N-th polynomials having the coefficient Z_{q}. In detail, if n is Φ(N), the polynomial indicates a polynomial which may be calculated as the remainder of dividing the polynomial by an N-th cyclotomic polynomial. (f(x)) indicates ideal of Z_{q}[x] generated by f(x). The Euler totient function Φ(N) indicates the number of natural numbers that are coprime to N and smaller than N. If Φ_{N}(x) is defined as the n-th cyclotomic polynomial, the ring may also be expressed in Equation 3 as follows.

$$R = {Z}_{q} [ X ] / {Φ}_{N} ( x ) \qquad [ Equation 3 ]$$

A secret key sk may be expressed as follows.

Meanwhile, the ring of Equation 3 described above has a complex number in a plaintext space. Meanwhile, only a set in which the plaintext space includes a real number among the sets of rings described above may be used to improve an operation speed of the homomorphic ciphertext.

If the ring is set in this way, the processor 530 may calculate the secret key sk from the ring.

$$sk ← ( 1 , s ( x ) ) , s ( x ) ∈ R \qquad [ Equation 4 ]$$

Here, s(x) indicates a random polynomial generated using a small coefficient.

In addition, the processor 530 may calculate a first random polynomial a(x) from the ring. The first random polynomial may be expressed as follows.

$$a ( x ) ← R \qquad [ Equation 5 ]$$

In addition, the processor 530 may calculate an error. In detail, the processor 530 may extract the error from a discrete Gaussian distribution or a distribution having a statistical distance close thereto. This error may be expressed as follows.

$$e ( x ) ← {D}_{α q}^{n} \qquad [ Equation 6 ]$$

If the error is even calculated, the processor 530 may calculate a second random polynomial by modularly operating the error on the first random polynomial and the secret key. The second random polynomial may be expressed as follows.

$$b ( x ) = - a ( x ) s ( x ) + e ( x ) ( mod q ) \qquad [ Equation 7 ]$$

Finally, a public key pk may be set to include the first random polynomial and the second random polynomial as follows.

$$pk = ( b ( x ) , a ( x ) ) \qquad [ Equation 8 ]$$

The above-described key generation method is only an example, the present disclosure is not necessarily limited thereto, and the public key and the secret key may be generated using another method.

Meanwhile, if the public key is generated, the processor 530 may control the communication device 510 to transmit the generated public key to other devices. Meanwhile, the processor 530 may store the secret key in the secure region of the memory 520 to prevent the secret key from being externally leaked.

In addition, the processor 530 may generate the operation key, as well as the secret key and the public key. In addition, the processor 530 may control the communication device 510 to transmit the corresponding operation key to the external device.

In addition, the processor 530 may receive the public key generated by another device as described above and use the same to generate the switching key. For example, the processor 530 may generate the switching key based on the second public key and the first secret key if the processor 530 receives the second public key from a second electronic apparatus corresponding to the first user. For example, the switching key described above is a key that enables the homomorphic ciphertext encrypted using the first public key to be decrypted using the second secret key corresponding to the second public key, and may be generated using a modulus P that is coprime to the modulus Q of the second public key. Here, the modulus P may be greater than the modulus Q of the second public key.

Meanwhile, the processor 530 may generate the individual switching keys respectively corresponding to the public keys if the plurality of second public keys are received.

The processor 530 may control the communication device 510 to transmit the generated switching key to another device.

The processor 530 may generate the homomorphic ciphertext for the message. In detail, the processor 530 may generate the homomorphic ciphertext by applying the previously-generated public key to the message. Here, the processor 530 may generate a length of the ciphertext to correspond to a size of a scaling factor.

If the homomorphic ciphertext is generated, the processor 530 may store the homomorphic ciphertext in the memory 520, or control the communication device 510 to transmit the homomorphic ciphertext to another device based on a user request or a predetermined default instruction.

Meanwhile, according to an embodiment of the present disclosure, packing may be used. The plurality of messages may be encrypted into one ciphertext if the packing is used in the homomorphic encryption. In this case, if the electronic apparatus 500 performs the operation on each of the ciphertexts, an operation burden may be greatly reduced as a result because the operations on the plurality of messages are processed in parallel.

In detail, if the message includes a plurality of message vectors, the processor 530 may convert the plurality of message vectors to a polynomial which may encrypt the message vectors in parallel, then multiply the polynomial by the scaling factor, and perform the homomorphic encryption by using the public key. Accordingly, the ciphertext may be generated by packing the plurality of message vectors.

In addition, if the decryption is necessary for the homomorphic ciphertext, the processor 530 may apply the secret key to the homomorphic ciphertext to thus generate a decrypted text in the polynomial form, and decode the decrypted text in the polynomial form to thus generate the message. Here, the generated message may include the error as mentioned in Equation 1 described above.

In addition, the processor 530 may perform the operation on the ciphertext. In detail, the processor 530 may perform the operation such as the addition or the multiplication on the homomorphic encryption while maintaining its encrypted state. In detail, the processor 530 may perform first function processing on each of the homomorphic encryptions to be used in the operation, perform the operation, such as the addition or the multiplication, on the first function-processed homomorphic ciphertexts, and perform second function processing on the operated homomorphic ciphertexts, a second function being an inverse function of a first function.

Meanwhile, if the operation is completed, the processor 530 may detect data in an effective region from operation result data. In detail, the processor 530 may detect the data in the effective region by performing rounding processing on the operation result data. The rounding process may refer to rounding off the message in the encrypted state, and may also be referred to as rescaling. In detail, the processor 530 may remove a noise region by multiplying each component of the ciphertext by Δ⁻¹, which is a reciprocal of the scaling factor, and rounding off the same. The noise region may be determined to correspond to the size of the scaling factor. As a result, the processor may detect the message in the effective region excluding the noise region. An additional error may occur because the process is performed in the encryption state. However, this error may be ignored because its size is sufficiently small.

In addition, the processor 530 may perform a reboot operation on the ciphertext if a proportion of an approximate message in the operation result ciphertext exceeds a threshold. Here, the processor 530 may perform the reboot operation using various methods. For example, the processor 530 may perform the reboot operation through processes of expanding the modulus of the operation result ciphertext, performing a first linear transformation on the homomorphic ciphertext having the expanded modulus into the polynomial form, performing an approximation operation on a first homomorphic ciphertext transformed into the polynomial form by using a function that is set to approximate a modulated range of the plaintext, performing a second linear transformation on a second homomorphic ciphertext approximated into a form of the homomorphic ciphertext.

In addition, the processor 530 may perform the switching operation on the ciphertext.

As described above, the electronic apparatus 500 according to an embodiment of the present disclosure may prevent the secret key of each device from being externally leaked, thus preventing information of other devices from being easily decrypted or leaked even if the switching key is leaked or some terminal devices and servers collude.

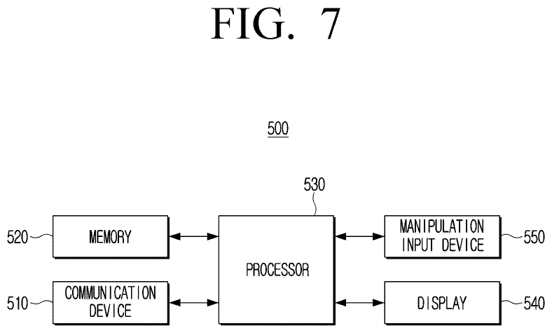

Meanwhile, hereinabove, the description shows and describes only the brief configuration of the electronic apparatus 100. However, in implementation, various configurations may be further provided. This configuration is described below with reference to FIG. 7.

FIG. 7 is a block diagram showing a configuration of the electronic apparatus according to an embodiment of the present disclosure.

Referring to FIG. 7, the electronic apparatus 500 may include the communication device 510, the memory 520, the processor 530, a display 540, and a manipulation input device 550.

The components such as the communication device 510, the memory 520, and the processor 530 are described above with reference to FIG. 6, and only the operations different from those shown in FIG. 6 are described below.

The display 540 may display a user interface window for selection of a function supported by the electronic apparatus 500. In detail, the display 540 may display the user interface window for selection of various functions provided by the electronic apparatus 500. The display 540 may be a monitor such as a liquid crystal display (LCD) or organic light emitting diodes (OLED), and may be implemented as a touch screen which may simultaneously perform a function of the manipulation input device 550 described below.

The display 540 may display a message requesting input of the parameter necessary for generating the secret key or the public key. In addition, the display 540 may display a message where an encryption target selects the message. Meanwhile, in implementation, the encryption target may be directly selected by the user or automatically selected. That is, the personal information that requires the encryption may be automatically set even if the user does not directly select the message.

The manipulation input device 550 may receive, from the user, selection of the function of the electronic apparatus 500 and a control command for the corresponding function. In detail, the manipulation input device 550 may receive, from the user, the parameter necessary for generating the secret key or the public key. In addition, the manipulation input device 550 may receive the message set to be encrypted from the user.

Meanwhile, the electronic apparatus 500 is described as including the display 540 with reference to FIG. 6. However, the component such as the display may be omitted if the electronic apparatus 500 is a device such as a set-top box or a PC body that includes no display. In addition, although not shown in FIG. 6, the electronic apparatus 500 may further include another component (e.g., camera or speaker).

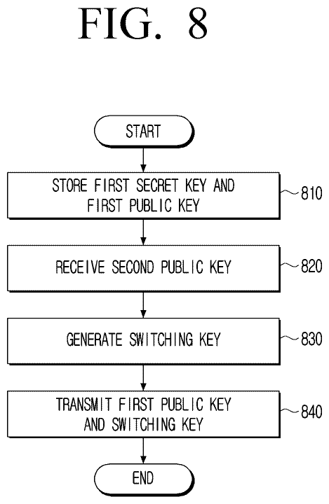

FIG. 8 is a flow chart for describing an operation for controlling the electronic apparatus according to an embodiment of the present disclosure.

Referring to FIG. 8, the electronic apparatus may first store the first secret key and the first public key corresponding to the first secret key (810). In detail, the first secret key may be calculated using the same method as Equation 4 based on the ring described above. In addition, if the first secret key is generated, the electronic apparatus may calculate the error, generate the first random polynomial and the second random polynomial, and generate the first public key based thereon. The first secret key may be stored in the secure region of the memory not to be externally leaked.

In addition, the electronic apparatus may generate the operation key in response to generating the above-described secret key and public key. For example, the electronic apparatus may generate the operation key based on the secret key. This operation key may be used for the specific homomorphic operation, such as the homomorphic multiplication or the homomorphic rotation, rather than for the encryption or the decryption.

In addition, the electronic apparatus may generate the first partial secret key and the second partial secret key that satisfy the mutual linearity based on the first secret key.

The electronic apparatus may receive the second public key from the terminal device corresponding to the first user (820). Here, the second public key may be the public key corresponding to the second secret key generated by the first user (or the first terminal device). For example, the electronic apparatus may receive the second public key of the first user from the terminal device corresponding to the first user. If the plurality of terminal devices participate in the homomorphic operation or the homomorphic computation, the plurality of second public keys may be received from the plurality of terminal devices, respectively.

In addition, the electronic apparatus may generate the switching key based on the second public key and the first secret key (830). For example, the electronic apparatus may generate the switching key by using the modulus P that is coprime to the modulus Q of the second public key, the first secret key, and the second public key. The switching key is a key that enables the homomorphic ciphertext that is encrypted using the first public key to be decrypted using the second secret key corresponding to the second public key. In this case, the modulus P may be greater than the modulus Q of the second public key.

Meanwhile, the electronic apparatus may generate the individual switching keys respectively corresponding to the second public keys of the plurality of terminal devices if the plurality of terminal devices participate in the homomorphic operation (or provide the ciphertext).

If the switching key is generated in this way, the electronic apparatus may transmit the generated switching key to the second server device, the first public key to the first terminal device, and the operation key to the first server device that performs the homomorphic operation (840). Meanwhile, in implementation, the first server device and the second server device may be the same device.

Meanwhile, in implementation, if the electronic apparatus is operated as in the embodiment of FIG. 5, the electronic apparatus may generate the partial secret key instead of the switching key and transmit the same to the second server device and the third server device. In this case, the generation of the switching key and the reception of the second public key described above may be omitted.

In the control method according to the present disclosure described above, the server secret key may be stored only in the electronic apparatus corresponding to a trusted authority and prevented from being externally leaked, thereby solving the problems that occur if a common secret key is shared among the users.

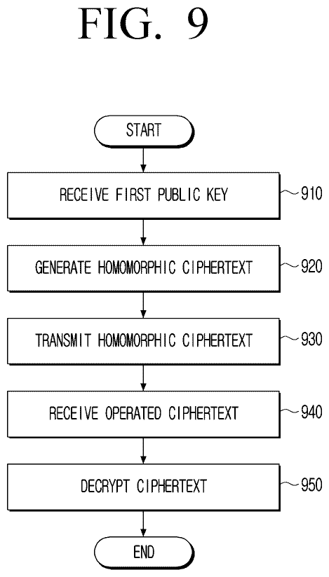

FIG. 9 is a flow chart for describing an operation for controlling the terminal device according to an embodiment of the present disclosure.

Referring to FIG. 9, the terminal device may generate the second secret key and the second public key. For example, the terminal device may calculate the second secret key by using the same method as Equation 4 based on the ring described above. In addition, if the second secret key is generated, the terminal device may generate the error, the first random polynomial, and the second random polynomial, and generate the second public key based thereon. The second secret key may be stored in the secure region of the memory not to be externally leaked.

In addition, the terminal device may transmit the second public key to the electronic apparatus for the generation of the switching key. Meanwhile, if the terminal device is operated as in the embodiment of FIG. 5, the second public key may be transmitted to the second server device or the third server device instead of the electronic apparatus.

In addition, the terminal device may receive the first public key from the electronic apparatus (910). Here, the first public key may be the public key corresponding to the first secret key of the server, and differ from the second public key generated by the terminal device.

If the first public key is received in this way, the terminal device may generate the homomorphic ciphertext based on the message and the first public key (920). For example, the terminal device may encode the message into the polynomial form and encrypt the encoded message by using the first public key to thus generate the homomorphic ciphertext. The homomorphic ciphertext may be decrypted using the first secret key, and is unable to be decrypted using the second secret key stored in the terminal device.

If the homomorphic ciphertext is generated, the terminal device may transmit the generated homomorphic ciphertext to the first server device (930).

In addition, the terminal device may receive the operation result of the homomorphic operation from the second server device (940). Here, the homomorphic ciphertext received by the terminal device may be the homomorphic ciphertext in which the secret key is changed from the first secret key to the second secret key to allow the terminal device to decrypt the homomorphic ciphertext.

Accordingly, the terminal device may decrypt the received homomorphic ciphertext by using the pre-stored second secret key (950). Meanwhile, if the terminal device is operated as in the embodiment of FIG. 5, the terminal device may receive the plurality of partial decryption results from the plurality of server devices and perform the operation of combining the received results. In addition, the ciphertext in which the partial decryption results are combined with each other may be decrypted using the second secret key.

In the method of controlling the terminal device according to the present disclosure as described above, the secret key of the terminal device is not leaked, thus preventing the information from being exposed to another terminal device.

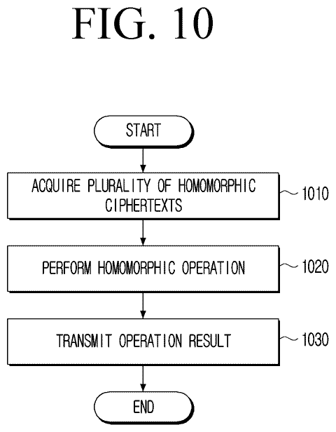

FIG. 10 is a flow chart for describing an operation for controlling the server device according to an embodiment of the present disclosure.

Referring to FIG. 10, the server device may receive the first public key and/or a first operation key from the electronic apparatus.

In addition, the server device may receive the homomorphic ciphertext from each of the plurality of terminal devices (1010). The homomorphic ciphertext may be the ciphertext homomorphically encrypted using the first public key.

Accordingly, the server device may perform the various operations (or the various homomorphic operations) on the plurality of homomorphic ciphertexts by using the first public key (or the first operation key) (1020).

In addition, the server device may transmit the operation result (1030). For example, the server device may transmit the operation result to another server device storing the switching key. Meanwhile, if the server device is operated as in the embodiment of FIG. 5, the server device may transmit the operation result to the plurality of decryption servers.

In the method for controlling the server device according to the present disclosure as described above, the different devices may perform the homomorphic operation and the key switching operation separately, thereby reducing the risk of collusion between the user and the server. In addition, the separate devices may perform the above-described operations and the key generation operation, thereby reducing the bottleneck phenomenon.

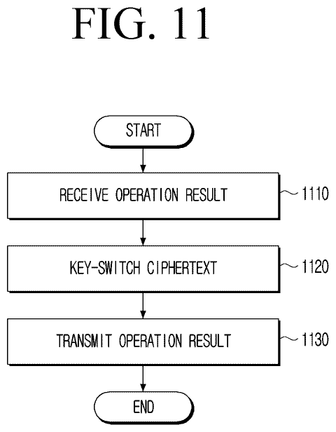

FIG. 11 is a flow chart for describing an operation for controlling the server device according to an embodiment of the present disclosure.

Referring to FIG. 11, the second server device may first receive the switching key from the electronic apparatus.

In addition, the second server device may receive the operation result from the first server device (1110).

In addition, the second server device may determine the terminal device to receive the operation result, and prepare the homomorphic ciphertext to be provided to each of the determined terminal devices (1120). For example, the second server device may key-switch the homomorphic ciphertext, decryptable using the first secret key S_{C}, by using the first switching key swk_{sc}->ₛₐ, decryptable using the second secret key of the first terminal device.

In addition, the second server device may transmit the key-switched homomorphic ciphertext to each of the terminal devices (1130). For example, the second server device may transmit the homomorphic ciphertext key-switched using the first switching key to the first terminal device corresponding to the first switching key, and the homomorphic ciphertext key-switched using the second switching key to the second terminal device corresponding to the second switching key.

Meanwhile, the different devices are described as performing the homomorphic operation and the switching key application, respectively. However, in implementation, a single device may perform the operations shown in FIGS. 9 and 10.

Meanwhile, the illustrated example assumes that the server device is operated as in the embodiment of FIG. 4, and the flow chart described above may be modified and applied in a manner corresponding to a corresponding embodiment if the server device is operated in an embodiment different from that of FIG. 4.

In the method for controlling the server device according to the present disclosure as described above, the different devices may perform the homomorphic operation and the key switching operation separately, thereby reducing the risk of collusion between the user and the server. In addition, the separate devices may perform the above-described operations and the key generation operation, thereby reducing the bottleneck phenomenon.

Meanwhile, the methods according to at least some of the various embodiments in the present disclosure described above may be implemented in the form of an application capable of being installed on a conventional electronic apparatus.

In addition, the methods according to at least some of the various embodiments of the present disclosure described above may be implemented only by software upgrade or hardware upgrade of the conventional electronic apparatus.

In addition, the methods according to at least some of the various embodiments of the present disclosure described above may be performed through an embedded server disposed in the electronic apparatus, or at least one external server of the electronic apparatus.

Meanwhile, according to an embodiment of the present disclosure, the various embodiments described above may be implemented in software including an instruction stored on a machine-readable storage medium (for example, a computer-readable storage medium). A machine may be a device that invokes the stored instruction from the storage medium, may be operated based on the invoked instruction, and may include the electronic apparatus (e.g., electronic apparatus A) according to the disclosed embodiments. If the instruction is executed by the processor, the processor may directly perform a function corresponding to the instruction or another component may perform the function corresponding to the instruction under the control of the processor. The instruction may include codes generated or executed by a compiler or an interpreter. The machine-readable storage medium may be provided in the form of a non-transitory storage medium. Here, the “non-transitory storage medium” refers to a tangible device and only indicates that this storage medium does not include a signal (e.g., electromagnetic wave), and this term does not distinguish a case where data is semi-permanently stored on the storage medium and a case where data is temporarily stored on the storage medium from each other. For example, the “non-transitory storage medium” may include a buffer in which data is temporarily stored. According to an embodiment, the methods according to the various embodiments disclosed in the present disclosure may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online (e.g., downloaded or uploaded) through an application store (e.g., PlayStore™) or directly between two user devices (e.g., terminal devices). In case of the online distribution, at least a part of the computer program product (e.g., downloadable app) may be at least temporarily stored or temporarily provided on the machine-readable storage medium such as a server memory of a manufacturer, a server memory of an application store, or a relay server memory.

The various embodiments of the present disclosure may be implemented by software including the instruction stored on the machine-readable storage medium (for example, the computer readable storage medium). A machine may be a device that invokes the stored instruction from the storage medium, may be operated based on the invoked instruction, and may include the electronic apparatus (e.g., electronic apparatus 100) according to the disclosed embodiments.

If the instruction is executed by the processor, the processor may directly perform the function corresponding to the instruction or another component may perform the function corresponding to the instruction under the control of the processor. The instruction may include the codes generated or executed by the compiler or the interpreter.

Although the embodiments of the present disclosure are shown and described as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic apparatus comprising:
a communication device;
a memory storing a first secret key and a first public key corresponding to the first secret key, and storing at least one instruction; and
a processor configured to execute the at least one instruction,
wherein the processor is configured to
generate a switching key based on a second public key and the first secret key if the processor receives the second public key from a terminal device corresponding to a first user, and
control the communication device to transmit the first public key to the terminal device,
the switching key being a key that enables a homomorphic ciphertext encrypted using the first public key to be decrypted using a second secret key corresponding to the second public key, and being generated using a modulus P that is coprime to a modulus Q of the second public key, the first secret key, and the second public key.

2. The apparatus as claimed in claim 1, wherein the modulus P is greater than
the modulus Q of the second public key.

3. The apparatus as claimed in claim 1, wherein the processor is configured to
receive the second public key from each of the plurality of terminal devices, and
generate the plurality of switching keys respectively corresponding to the received plurality of second public keys.

4. The apparatus as claimed in claim 1, wherein the processor is configured to
generate the first public key based on the first secret key, and
store the first secret key in a secure region of the memory to prevent the first secret key from being externally leaked from the electronic apparatus.

5. The apparatus as claimed in claim 1, wherein the processor is configured to
generate a first operation key based on the first secret key, and
control the communication device to provide the first operation key to a first server device performing a homomorphic operation on a plurality of homomorphic ciphertexts.

6. The apparatus as claimed in claim 5, wherein the processor is configured to control the communication device to transmit the switching key to a second server device providing a homomorphic operation result of the first server device to each electronic apparatus.

7. The apparatus as claimed in claim 1, wherein the processor is configured to generate a first partial secret key and a second partial secret key that satisfy mutual linearity based on the first secret key.

8. A method for controlling an electronic apparatus, the method comprising:
storing a first secret key and a first public key corresponding to the first secret key;
receiving a second public key from a terminal device corresponding to a first user;
generating a switching key based on the second public key and the first secret key; and
transmitting the first public key to the terminal device,
wherein the switching key is a key that enables a homomorphic ciphertext encrypted using the first public key to be decrypted using a second secret key corresponding to the second public key, and is generated using a modulus P that is coprime to a modulus Q of the second public key, the first secret key, and the second public key.

9. The method as claimed in claim 8, wherein the modulus P is greater than the modulus Q of the second public key.

10. The method as claimed in claim 8, wherein in the receiving of the second public key,
the second public key is received from each of the plurality of terminal devices, and
in the generating of the switching key,
the plurality of switching keys respectively corresponding to the received plurality of second public keys are generated.

11. The method as claimed in claim 8, further comprising:
generating the first public key based on the first secret key; and
storing the first secret key in a secure region of a memory to prevent the first secret key from being externally leaked from the electronic apparatus.

12. The method as claimed in claim 8, further comprising:
generating a first operation key based on the first secret key; and
providing the first operation key to a first server device performing a homomorphic operation on a plurality of homomorphic ciphertexts.

13. The method as claimed in claim 12, further comprising transmitting the switching key to a second server device providing a homomorphic operation result of the first server device to each electronic apparatus.

14. The method as claimed in claim 12, further comprising generating a first partial secret key and a second partial secret key that satisfy mutual linearity based on the first secret key.

15. A non-transitory computer-readable recording medium storing a program for executing a method for controlling an electronic apparatus, wherein the method includes
storing a first secret key and a first public key corresponding to the first secret key,
receiving a second public key from a terminal device corresponding to a first user,
generating a switching key based on the second public key and the first secret key, and
transmitting the first public key to the terminal device,
wherein the switching key is a key that enables a homomorphic ciphertext encrypted using the first public key to be decrypted using a second secret key corresponding to the second public key, and is generated using a modulus P that is coprime to a modulus Q of the second public key, the first secret key, and the second public key.
